(19) United States
(12) Patent Application Publication
(10) Pub. No.: US 2023/0047112 A1
(43) Pub. Date: Feb. 16, 2023

(54) METHOD FOR PROCESSING INFORMATION, STORAGE MEDIUM, AND INFORMATION PROCESSING DEVICE

(71) Applicant: Mercari, Inc., Tokyo (JP)

(72) Inventors: Masato Yamamoto, Tokyo (JP); Satoshi Kaji, Tokyo (JP); Mayumi Numasaki, Tokyo (JP)

(21) Appl. No.: 17/883,458

(22) Filed: Aug. 8, 2022

(30) Foreign Application Priority Data
Aug. 13, 2021 (JP) 2021-132046

(51) Int. Cl. G06Q 20/14; G06Q 20/10; G06Q 40/02

(52) U.S. Cl. CPC G06Q 20/14; G06Q 20/102; G06Q 40/025

(57) ABSTRACT

The purpose of the present disclosure is to enhance the degree of freedom for settlement, even once the settlement method has been selected by the user. A method for processing information makes an information processing device execute: acquiring information from a unit storing settlement history information including at least one piece of settlement information on each of a plurality of users, the acquired information containing at least one piece of settlement information on a first user; specifying at least one piece of settlement information from the settlement history information, in response to operation by the first user with another information processing device, on which the settlement history information is displayed; displaying an amount of money based on a settlement amount included in the at least one piece of settlement information on the other information processing device, the displayed amount being an amount to be loaned to the first user; and lending the amount of money determined in response to the operation by the first user with the other information processing device to the first user.

### CROSS-REFERENCE TO RELATION APPLICATION

This application is a continuation application of Japanese Patent Application No. 2021-132046, filed with the Japanese Patent Office on Aug. 13, 2021, and entitled “METHOD FOR PROCESSING INFORMATION, STORAGE MEDIUM, AND INFORMATION PROCESSING DEVICE”, which is incorporated herein by reference in its entirety.

### BACKGROUND

The present disclosure relates to a method for processing information, a storage medium, and an information processing device.

### DESCRIPTION OF RELATED ART

Conventionally, techniques have been known for selecting the settlement method in electronic payment, which enables the selection of lump-sum payment, installment payment, revolving payment, and others (see, for example, Japanese Unexamined Patent Application Publication No. 2021-47495).

### SUMMARY

The conventional techniques, however, do not give users a great degree of freedom in change of the settlement method once it has been selected. For example, once a settlement, such as a lump-sum payment, has been completed, the user may not be able to make any changes to the settlement.

The present disclosure therefore aims to provide a method for processing information, a storage medium, and an information processing device capable of increasing the degree of freedom for settlement even after a user has selected a settlement method.

A method for processing information according to one embodiment of the present disclosure makes one or more processors included in a first information processing device execute: acquiring settlement history information from a unit storing settlement history information including at least one piece of settlement information on each of a plurality of users, the acquired settlement history information containing at least one piece of settlement information on a first user; specifying the at least one piece of settlement information from the settlement history information, in response to operation by the first user with a second information processing device, on which the settlement history information is displayed; displaying an amount of money based on a settlement amount included in the at least one piece of settlement information on the second information processing device, the displayed amount being an amount to be loaned to the first user; and lending the amount of money determined in response to the operation by the first user with the second information processing device to the first user.

### BRIEF DESCRIPTION OF DRAWINGS

FIG. 1 is a block diagram showing an example configuration of an information processing system according to one embodiment, an example hardware configuration of a server according to the present disclosure, and an example hardware configuration of a terminal according to the present disclosure.

FIG. 2 shows an example of user information according to one embodiment.

FIG. 3 shows an example of account information according to one embodiment.

FIG. 4 shows an example of settlement information according to one embodiment.

FIG. 5 shows an example of transaction information according to one embodiment.

FIG. 6 shows an example of the sequence of processing by the information processing system according to one embodiment.

FIG. 7 shows an example of settlement history displayed on the screen of a terminal according to one embodiment.

FIG. 8 shows an example of screen transitions related to the loan displayed on the screen of a terminal according to one embodiment.

### DETAILED DESCRIPTION

Compliance with Laws and Regulations

The disclosures described herein will be embodied in compliance with the laws and regulations of each country in which this disclosure is embodied. The disclosures herein are also embodied with all changes, substitutions, alterations, modifications, or amendments that those skilled in the art may make, as necessary to comply with the laws and regulations of each country.

Referring to the drawings, the following describes an embodiment for a method for processing information, a storage medium and an information processing device according to the present disclosure.

System Configuration

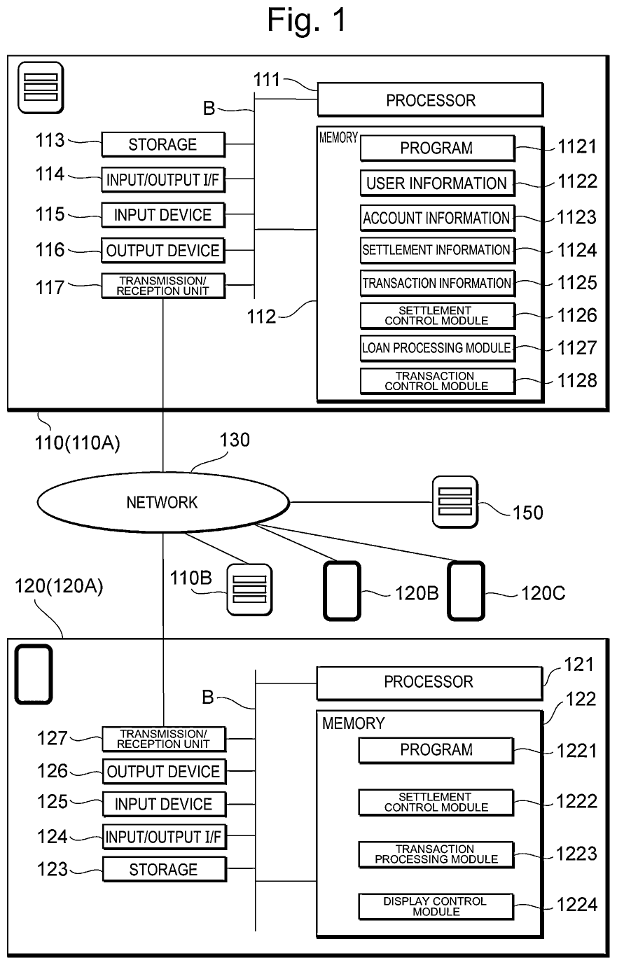

FIG. 1 shows the configuration of an information processing system 1 according to one embodiment of the present disclosure. In the information processing system 1, a server 110A, a server 110B, a terminal 120A, a terminal 120B, a terminal 120C, and a server 150 linked with a server 110A are connected via a network 130. For example, the server 110A, which is linked with the server 150, is able to acquire information related to a service (e.g., a settlement service or an electronic commerce (hereinafter this may be called e-commerce) service) provided by the server 150.

If it is not necessary to distinguish between the servers 110A and 110B, the servers 110A and 110B may each be referred to as the server 110. The number of the servers 110 connected to the network 130 is not limited.

If it is not necessary to distinguish between the terminals 120A, 120B, and 120C, the servers 120A, 120B, and 120C may each be referred to as the terminal 120. The number of the terminals 120 connected to the network 130 is not limited.

The server 110 provides predetermined services to the terminal 120 that a user operates via the network 130. The predetermined services include, but are not limited to, settlement services, financial services, e-commerce services, SNS (social networking services) such as instant messaging services, and content provision services such as for songs, videos, and books. The server 150 constructs, for example, an e-commerce platform, and provides an e-commerce service, for example, to the terminal 120. The servers 110 and 150 may independently provide one or more services, or a plurality of servers 110 and 150 together may provide one or more services. The servers 110 and 150 provide their respective services to one or more terminals 120, so that users can use the respective services through their terminals 120.

Hereinafter, the terminal used by user X is described as terminal 120X, and the information associated with the user X or the terminal 120X and associated with the user in a predetermined service is described as user information X, as needed. Examples of the user information, but are not limited to, include the user's name, the user's icon image, the user's age, the user's gender, the user's address, the user's hobbies and tastes, information associated with the user such as the identifier of the user, balance information of electronic value (electronic money) associated with the user, and credit card information associated with the user (credit card number, etc.), which are input by the user or are given through a predetermined service.

The network 130 connects two or more servers 110, 150, or two or more terminals 120. After connecting the terminals 120 to the servers 110 and 150, the network 130 provides a connection route so that the terminals 120 can send and receive data.

One or more parts of the network 130 may be a wired network or a wireless network.

Examples of the network 130, but are not limited to, include ad-hoc network, intranet, extranet, virtual private network (VPN), local area network (LAN), wireless LAN (WLAN), wide area network (WAN), wireless WAN (WWAN), metropolitan area network (MAN), part of the internet, part of public switched telephone network (PSTN), mobile network, integrated service digital networks (ISDNs), wireless LANs, long term evolution (LTE), code division multiple access (CDMA), Bluetooth (registered trademark), satellite communications, and a combination of them. The network 130 may include one or more networks 130.

The servers 110, 150, and the terminals 120 may be any information processing device as long as it can implement the processing, functions, or methods described in the present disclosure.

Examples of the servers 110, 150, and the terminals 120 include, but are not limited to, smartphones, cellular phones (feature phones), computers (examples, but are not limited to, include desktops, laptops, and tablets), servers, media computer platforms (examples, but are not limited to, include cables, satellite set top boxes, and digital video recorders), handheld computer devices (examples, but are not limited to, include personal digital assistants (PDAs), and email clients), wearable terminals (examples, but are not limited to, include glasses type devices, and watch type devices), other types of computers, communication platforms, and a combination of them.

Hardware configuration of information processing devices

(1) Server Hardware Configuration

Referring to FIG. 1, the following describes the hardware configuration of the server 110 included in the information processing system 1.

The server 110 includes a processor 111, a memory 112, a storage 113, an input/output interface (input/output I/F) 114, an input device 115, an output device 116, and a transmission/reception unit 117. These hardware components of the server 110 are interconnected via bus B, as an example, but not limited to.

The server 110 implements the processing, functions, or methods described in the present disclosure through the cooperation of the processor 111, the memory 112, the storage 113, the input/output I/F 114, and the transmission/reception unit 117.

The processor 111 executes the processing, functions, or methods to be implemented in accordance with the codes or instructions contained in a program stored in the storage 113. Examples of the processor 111, but are not limited to, include one or more central processing units (CPUs), micro processing units (MPUs), graphics processing units (GPUs), microprocessors, processor cores, multiprocessors, application-specific integrated circuits (ASICs), and field programmable gate arrays (FPGAs), and may implement the processing, functions and methods disclosed in the following embodiments by means of a logic circuit (hardware) or a dedicated circuit formed in an integrated circuit (IC) chip, a large scale integration (LSI), and the like. These circuits may be in the form of one or more integrated circuits, and the multiple processes shown in each embodiment may be implemented with a single integrated circuit. LSIs may be referred to as VLSIs, super LSIs, or ultra LSIs, depending on the level of integration.

The memory 112 temporarily stores a program 1121 loaded from the storage 113 and provides a work area for the processor 111. The memory 112 also temporarily stores various data generated while the processor 111 is executing the program. Examples of the memory 112, but are not limited to, include a random access memory (RAM), a read only memory (ROM), and a combination of them. The storage 113 stores programs and various data. Examples of the storage 113, but are not limited to, include a hard disk drive (HDD), a solid state drive (SSD), a flash memory, and a combination of them.

The input/output I/F 114 connects to the input device 115 that receives various input operations to the server 110 and an output device 116 that outputs the processing results processed by the server 110.

The input device 115 is implemented by any one of all kinds of devices capable of receiving an input from a user and transmitting information related to the input to the processor 111 via the input/output I/F 114 or by a combination of these devices. Examples of the input device, but are not limited to, include a touch panel, a touch display, a hardware key such as a keyboard, a pointing device such as a mouse, a camera (operation for inputting via an image), a microphone (operation for inputting by voice), and a combination of them.

The output device 116 is implemented by any one of all kinds of devices capable of outputting the processing result of the processor 111 via the input/output I/F 114 or by a combination of these devices. When outputting the processing result in the form of video or moving images, the output device 116 is implemented by any one of all kinds of devices capable of displaying the display data according to the display data written in the frame buffer, or a combination of these devices. Examples of the output device 116, but are not limited to, include a touch panel, a touch display, a monitor (examples, but are not limited to, include a liquid crystal display, and an organic electroluminescence display (OELD)), a head mounted display (HMD), projection mapping, hologram, a device that can display images, text information, etc. in the air (even a vacuum), a speaker (audio output), a printer, and a combination of them. These output devices may be capable of displaying the display data in 3D.

The input device 115 and the output device 116 may be integrated, or the input device 115 and the output device 116 may be separated.

The transmission/reception unit 117 transmits/receives various data via the network 130. These communications may be performed by either wired or wireless, and any communication protocol may be used as long as it enables mutual communication. The transmission/reception unit 117 has the function of executing a communication with other information processing devices via the network 130. The transmission/reception unit 117 transmits various data to other information processing devices according to instructions from the processor 111. The transmission/reception unit 117 also receives various data from other information processing devices, and transmits them to the processor 111. The server 150 has the same components as the server 110 has and the descriptions thereon are omitted for the server 150.

(2) Hardware Configuration of Terminal 120

Referring to FIG. 1, the following describes the hardware configuration of the terminal 120 included in the information processing system 1.

The terminal 120 has a processor 121, a memory 122, a storage 123, an input/output I/F 124, an input device 125, an output device 126, a transmission/reception unit 127, and a reading unit 128. These hardware components of the terminal 120 are interconnected via bus B, as an example, but not limited to.

The terminal 120 implements the processing, functions, or methods described in the present disclosure through the cooperation of the processor 121, the memory 122, the storage 123, the input/output I/F 124, the input device 125, the output device 126, the transmission/reception unit 127, and the reading unit 128.

The processor 121 executes the processing, functions, or methods to be implemented in accordance with the codes or instructions contained in a program stored in the storage 123. Examples of the processor 121, but are not limited to, include a central processing unit (CPU), a micro processing unit (MPU), a graphics processing unit (GPU), a microprocessor, a processor core, a multiprocessor, an application-specific integrated circuit (ASIC), and a field programmable gate array (FPGA), and may implement the processing, functions and methods disclosed in the following embodiments by means of a logic circuit (hardware) or a dedicated circuit formed in an integrated circuit (IC) chip, a large scale integration (LSI), and the like. These circuits may be in the form of one or more integrated circuits, and the multiple processes shown in each embodiment may be implemented with a single integrated circuit. LSIs may be referred to as VLSIs, super LSIs, or ultra LSIs, depending on the level of integration.

The memory 122 temporarily stores a program 1221 loaded from the storage 123 and provides a work area for the processor 121. The memory 122 also temporarily stores various data generated while the processor 121 is executing the program 1221. Examples of the memory 122, but are not limited to, include a random access memory (RAM), a read only memory (ROM), and a combination of them.

The storage 123 stores programs and various data. Examples of the storage 123, but are not limited to, include a hard disk drive (HDD), a solid state drive (SSD), a flash memory, and a combination of them.

The input/output I/F 124 connects to the input device 125 that receives various input operations to the terminal 120 and an output device 126 that outputs the processing results processed by the terminal 120.

The input device 125 is implemented by any one of all kinds of devices capable of receiving an input from a user and transmitting information related to the input to the processor 121 or by a combination of these devices. Examples of the input device, but are not limited to, include a touch panel, a touch display, a hardware key such as a keyboard, a pointing device such as a mouse, a camera (operation for inputting via an image), a microphone (operation for inputting by voice), and a combination of them.

The output device 126 is implemented by any one of all kinds of devices capable of outputting the processing result of the processor 121 or by a combination of these devices. When outputting the processing result in the form of video or moving images, the output device 126 is implemented by any one of all kinds of devices capable of displaying the display data according to the display data written in the frame buffer, or a combination of these devices. Examples of the output device, but are not limited to, include a touch panel, a touch display, a monitor (examples, but are not limited to, include a liquid crystal display, and an organic electroluminescence display (OELD)), a head mounted display (HMD), projection mapping, hologram, a device that can display images, text information, etc. in the air (even a vacuum), a speaker (audio output), a printer, and a combination of them. These output devices may be capable of displaying the display data in 3D.

The input device 125 and the output device 126 may be integrated, or the input device 125 and the output device 126 may be separated.

The transmission/reception unit 127 transmits/receives various data via the network 130. These communications may be performed by either wired or wireless, and any communication protocol may be used as long as it enables mutual communication. The transmission/reception unit 127 has the function of executing a communication with other information processing devices via the network 130. The transmission/reception unit 127 transmits various data to other information processing devices according to instructions from the processor 121. The transmission/reception unit 127 also receives various data from other information processing devices, and transmits them to the processor 121.

(3) Others

Cloud computing, including one or more information processing devices, may implement at least some of the processing, functions, or methods in the servers 110, 150, or the terminals 120.

Another information processing device may implement at least some of the processing, functions, or methods in the servers 110, 150, or the terminals 120. In this case, the processor of the other information processing device may implement at least part of the processing implemented by the processor 111 or the processor 121.

Programs for executing the processing of each embodiment of the present disclosure may be provided as being stored in a computer-readable storage medium. The storage medium is a “non-transitory tangible medium” capable of storing a program. Examples of the program, but are not limited to, include a software program and a computer program.

Examples of the storage medium may be one or more semiconductor-based or other integrated circuits (ICs) (examples, but are not limited to, include field programmable gate arrays (FPGAs), and application specific ICs (ASICs)), hard disk drives (HDDs), hybrid hard drives (HHDs), optical disks, optical disk drives (ODDs), magneto-optical disks, magneto-optical drives, floppy diskettes, floppy disk drives (FDDs), magnetic tape, solid-state drives (SSDs), RAM drives, secure digital cards or drives, any other suitable storage medium, and a combination of them. The storage medium may be volatile, nonvolatile, or a combination of volatile and nonvolatile.

The program of this disclosure may be provided to the servers 110, 150, or the terminals 120 via any transmission medium capable of transmitting the program (e.g., communication network, and broadcast waves).

Each embodiment of the present disclosure may also be implemented in the form of a data signal embedded in a carrier wave, in which the program is embodied by electronic transmission.

The program in this disclosure may be implemented with the following languages, but are not limited to, including script languages such as JavaScript (registered trademark) and Python, C language, Go language, Swift (registered trademark), Kotlin (registered trademark), and Java (registered trademark).

### Others

Unless explicitly mentioned, the configuration for determination in the embodiments of the present disclosure is not essential, and a predetermined process may be operated when the determination condition is satisfied, or a predetermined process may be performed when the determination condition is not satisfied.

This disclosure encompasses all changes, substitutions, alterations, modifications, or amendments that one skilled in the art may make to this disclosure. The appended claims also encompass all changes, substitutions, alterations, modifications, or amendments that may be made by those skilled in the art to the claims. The present disclosure encompasses any combination of one or more features of an embodiment or an example in the present disclosure and one or more features of another embodiment or an example in the present disclosure that may be made by those skilled in the art.

Reference in the appended claims to a device or system or a component of a device or system being adapted to, being arranged to, having ability to, being configured to, being enabled to, being operable to, or being operative to perform a particular function encompasses that device, system, or component whether or not it or that particular function is activated, turned on, or unlocked, as long as that device, system, or component is adapted, is arranged, has ability, is configured, is enabled, is operable, or is operative in such a manner.

Unless expressly stated otherwise, this disclosure may obtain consent from the user prior to, or immediately prior to, implementing any of the embodiments or examples. The consent to be obtained may be comprehensive or the consent may be obtained on a case-by-case basis.

### Embodiment

The following embodiment lets a user select at least one of the settlements (payments) from their settlement history (their payment history), for example, so as to allow the user to change the settlement method from the one selected during the settlement (e.g., lump-sum payment) to another settlement method (e.g., installment payment or fixed-amount payment). The following embodiment also lends, to the user, an amount of money less than or equal to the settlement amount in the settlement that has been cleared, thus allowing the user to experience a pseudo fixed-amount payment, installment payment, and the like.

The embodiment has an advantageous effect of, even once the user selects a settlement method (a payment method), allowing the user to change the settlement method depending on the situation, and thus enhancing the degree of freedom for settlement. The embodiment has another advantageous effect of lending an amount of money less than or equal to the settlement amount for the settlement that has been cleared, thus enhancing the user's degree of freedom for settlement without delaying the payment to the seller.

Configuration of the Embodiment

Referring to FIG. 1, the following describes the configurations of the server 110 (a first information processing device) and the terminal 120 (a second information processing device).

(1) Server Configuration

The server 110 includes a processor 111, a memory 112, a storage 113, an input/output interface 114, an input device 115, an output device 116, and a transmission/reception unit 117.

The processing, functions, or methods implemented through the execution by the processor 111 may be realized by machine learning, AI (artificial intelligence), or the like within a feasible range.

The input/output I/F 114 receives various setting operations from the business operator that operates various services provided by the server 110 through the input device 115 or the output device 116.

The transmission/reception unit 117 transmits and receives data to and from the terminal 120 and other devices in accordance with an instruction from the processor 111. In one example, when the user of the terminal 120 and other devices is authenticated with the user ID and password included in a login request from the terminal 120, the transmission/reception unit 117 connects a session for communication with the terminal 120 and other devices using HTTPS. Then, the transmission/reception unit 117 stores information such as the communication address of the terminal 120 and the user ID in association with the ID of the connected communication session. Then, the transmission/reception unit 117 transmits data to the terminal 120 and other devices using the connected communication session.

In this embodiment, the memory 112 stores a program 1121, user information 1122, account information 1123, settlement information 1124, transaction information 1125, a settlement control module 1126, a loan processing module 1127, a transaction control module 1128 and a data structure, or a subset thereof. The information stored in the memory 112 may be stored in another storage device (e.g., a storage 113).

As described above, the program 1121 is a program loaded from the storage 113, and contains instructions, for example, related to the processing in the embodiment. The program 1121 may also contain instructions for executing a process of providing an e-commerce service and/or a settlement service to the user.

The user information 1122 contains information on a user registered in a settlement service that performs electronic payment. The user information 1122 may be shared with the business operator that provides the e-commerce platform.

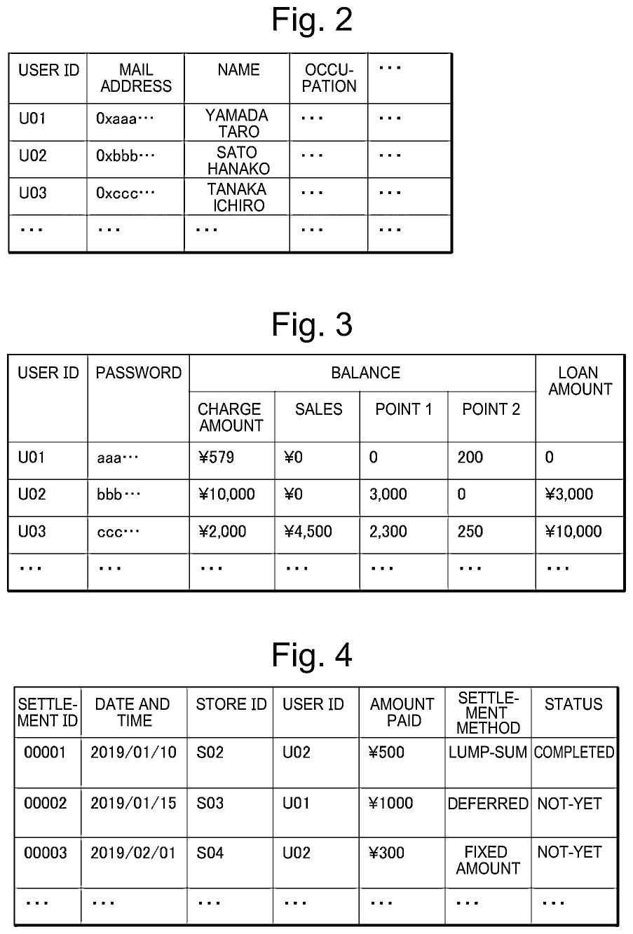

FIG. 2 shows an example of the user information 1122 according to one embodiment. The user information contains information on each member user for management, which is created by a settlement business operator that operates and manages the settlement service. The “User ID” includes user identification information (user ID: identifier) for the server 110 to uniquely identify the user. The “Email address” includes an email address registered by the user. The “Name” includes the user's name. The “Occupation” includes the occupation registered by the user. In addition to the above example, the user information may include an annual income, an address, a date of birth, whether or not the user has a driver's license, and the driver's license number if the user has a driver's license.

FIG. 3 shows an example of the account information 1123 according to one embodiment. The account information contains information on the account of each user for management, which is created by the settlement service provider, for example. In one example, the settlement service provider may operate and manage the e-commerce platform. The “User ID” includes user identification information for the server 110 to uniquely identify the user. The “Password” includes the password for user authentication. The “Balance” includes the balance of electronic money (or electronic value) of the account owned by the user. In one example, the electronic money is a monetary value that can convert cash to data for settlement.

In the example shown in FIG. 3, the balance includes the charge amount, sales (the amount of sales), point 1, and point 2. The types are an example, and the embodiment is not limited to these. In one example, the charge amount indicates the amount of money that the user has deposited from their bank account to the account created by the settlement service provider. In one example, the sales indicate the profit that the user obtains when selling a product that has been listed on the linked e-commerce platform. In one example, point 1 indicates the point that the user obtains through the conversion of the sales, and the user can use this point on the linked e-commerce platform. In one example, point 2 is given by another party such as the settlement service provider, and the user can use this point on the linked e-commerce platform.

For the charge amount, the user enters their own bank account information with the application provided by the settlement service provider to associate the user ID with the bank account. Upon completion of the identity verification, the user is allowed to charge any amount of money to the balance of their account. In addition to bank accounts, the charge amount can also be charged at convenience stores, for example. Hereinafter, if the identity verification based on the Act on Prevention of Criminal Proceeds has been completed, it will be described as “after identity verification”, and if the identity verification has not been completed, it will be described as “before identity verification”.

Point 1 is a paid point that the user obtains through the conversion of the sales before connection with the bank, and the user can use this point for a transaction on the e-commerce platform. Point 1 may have a set expiration period. In one example, the expiration period is six months. After connecting with the bank, money can be transferred from the amount of sales to the bank account. The user therefore does not have to convert the sales into point 1 and hold the points. This means that point 1 that the user has before the bank connection will gradually decrease by use. The bank connection refers to a state in which the user's account and the bank account owned by the user are linked with each other.

Point 2 is a free point distributed or granted by the settlement service provider, for example, as a bonus. Point 2 may have a set expiration period. The expiration period of point 2 may be set shorter than that of point 1.

In one example, the loan amount represents the amount of money that the user has received as a loan from the settlement service provider, for example, based on a loan contract. In principle, the money to be loaned is legal tender, which may include points, cryptocurrencies and crypto-assets.

The settlement information 1124 includes information on settlements that have been completed (cleared) for products and other settlements that have not been completed such as deferred payment at stores and on the e-commerce platform. In another embodiment, the settlement information 1124 may include information only on settlements that have been completed, and the transactions being settled may be managed as separate data.

FIG. 4 shows an example of the settlement information 1124 according to one embodiment. The settlement information (payment information) may be any information pertaining to the settlement. For example, the settlement information is information generated by a settlement terminal (a payment terminal) when the user purchases a product, for example, and transmitted to the server 110. The “Settlement ID” includes identification information (settlement ID) to identify the settlement. The “Date and time” includes the date and time when the electronic payment is completed. In one example, the electronic payment may include a settlement using a two-dimensional code and a credit card payment. The “Store ID” includes store information (also referred to as a store ID) of the store where the electronic payment was made. The store may have a plurality of POS terminals. In this case, the store ID may be the ID of each POS terminal. The “Amount paid” includes the amount of settlement when the electronic payment is made. The “Settlement method” includes information on the settlement method used for the settlement. In one example, the settlement method is one of the following: lump-sum payment, deferred payment to be paid in a lump sum after the following month or later, fixed-amount deferred payment to be settled in a fixed amount from the following month, convenience store payment, credit card payment, balance payment, and bonus payment. A plurality of settlement methods may be selected for one settlement. The “Status” includes information indicating “completed” when the settlement (clearing) is completed, and information indicating “not yet” when the settlement is not completed. The settlement information may include other types of information such as withdrawal information, remittance information, and clearing information.

When the server 110 works with an e-commerce service provided by the e-commerce platform, the transaction information 1125 contains transaction information regarding the sale and purchase of products on the e-commerce platform.

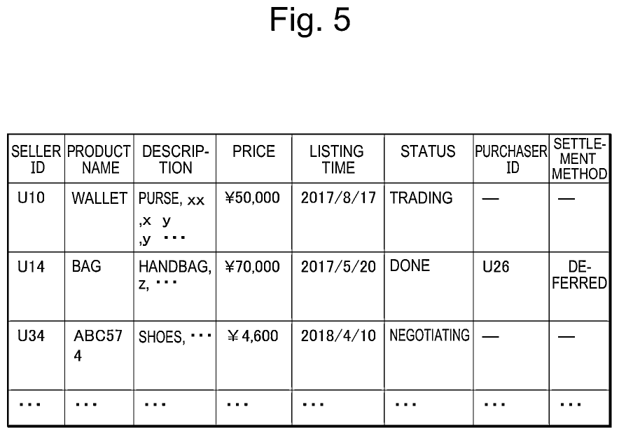

FIG. 5 shows an example of the transaction information 1125 according to one embodiment. The “Seller ID” includes the user ID of the user as the seller. The “Product name” includes the name of the product. The “Description” includes the description on the product. The “Price” includes the sales price of the product. The “Product name”, “Description”, and “Price” may be included in the listing information on the product, which may also include other types of information. The “Listing Time” includes the time when the product was listed. The “Status” includes the status of the transaction in the electronic commerce. The status may include “trading” to indicate that it is currently in transaction, “negotiating” to indicate that it is in negotiation with a user who is a buyer, and “done” to indicate that it has been sold. The “Purchaser ID” includes the user ID of the user who purchased the product. The “Settlement method” includes the settlement method used by the purchaser to purchase the product.

Referring back to FIG. 1, the settlement control module 1126 stored in memory 112, which is executed by processor 111, executes the settlement processing for the product purchase by each user at each member store and on the e-commerce platform. For example, the settlement process at the store is managed by the settlement information shown in FIG. 4, and the settlement process on the e-commerce platform is managed by the transaction information shown in FIG. 5.

The loan processing module 1127, which is stored in the memory 112, executes a process of lending a predetermined amount of money to the user based on the loan agreement and in response to a request from the user. In one example, the loan processing module 1127 executes the processing of acquiring information required for loaning, screening processing, and loaning processing. At least one part of the process of acquiring information required for loaning, screening, and loaning may be executed by another operator's server (e.g., server 150).

When the settlement service provider provides the e-commerce platform, the transaction control module 1128, which is stored in memory 112 and is executed by processor 111, controls the purchase and sale transactions on the e-commerce platform. In one example, the transaction control module 1128 controls various processing such as user registration, listing processing, purchase/sales transaction processing, evaluation processing, and electronic value management processing on the electronic commerce platform. The transaction control module 1128 may be located on another operator's server (e.g., server 150).

The following describes a process that, even after the settlement (clearing) has been completed by the settlement method (e.g., lump-sum payment) specified during the purchase of a product at a store or on an e-commerce platform, lends a predetermined amount of money to the user so as to allow the user to experience installment or fixed-amount payment.

The settlement control module 1126 acquires settlement history information containing one or more pieces of settlement information on a first user in response to an acquisition request for settlement history from the first user. In one example, the settlement control module 1126 may configure an acquisition unit that acquires settlement history information on the first user from the transmission/reception unit 117 or the memory 112. In a specific example, the settlement control module 1126 filters out the settlement information on the first user from the settlement information stored in the memory 112 (see, for example, FIG. 4) to obtain the settlement history information that includes one or more pieces of the settlement information on the first user.

After acquiring the settlement history information on the first user, the settlement control module 1126 transmits the settlement history information to the terminal 120 that the first user uses via the transmission/reception unit 117. Assume a case where the first user operates the terminal 120 to select at least one piece of settlement information from the list of settlement history information displayed on the screen and request a loan.

In this case, the settlement control module 1126 acquires the loan request transmitted from the terminal 120 and the settlement identification information indicating the selected piece of settlement information. When acquiring the loan request, the settlement control module 1126 specifies at least one piece of settlement information from the settlement history information, based on the settlement identification information. In one example, the settlement control module 1126 may configure a specifying unit that specifies the settlement information corresponding to the settlement identification information from the settlement history information.

The loan processing module 1127 executes a processing of lending an amount of money to the first user based on the settlement amount contained in the at least one piece of settlement information specified by the settlement control module 1126 (e.g., the amount of money less than or equal to the settlement amount, or less than or equal to the settlement amount that is less than or equal to the maximum loan amount, and the amount calculated by rounding off a fraction of the settlement amount). The loan amount may be determined by the user. In one example, the loan processing module 1127 may be configured to display the amount of money based on the settlement amount on the terminal 120 (suggest it to the user), and then allow the user to determine the amount of money at their discretion. In one example, the loan processing module 1127 identifies the user information on the first user from the user information 1122 (see, for example, FIG. 2) stored in the memory 112 and obtains the information necessary for the loan. The information required for loan may be preset based on the rules of the money lending business.

Before the loan processing, the loan processing module 1127 also transmits an acquisition request for the information that needs to be acquired each time for loan (e g, annual income, purpose of use, and amount borrowed from other companies) together with the items on the information to be acquired to the terminal 120. If some of the information required for the loan is missing from the information registered in the user information on the first user, the loan processing module 1127 transmits the item(s) of the missing information together with the acquisition request.

When the required information is entered or set through the operation by the first user with the terminal 120, the loan processing module 1127 obtains the required information transmitted from the terminal 120 via the transmission/reception unit 117. The loan processing module 1127 uses the information required for the loan for screening about whether or not the loan is approvable. In one example, the loan processing module 1127 sends the information required for the loan to an organization that examines the user's credit information, such as the Credit Information Center (CIC), which is a designated credit information agency, and receives a response for the credit information on the first user.

If there are no particular problems with the credit information, the loan processing module 1127 determines that the loan is approvable, and lends the predetermined amount of money to the first user. The repayment method sent with the loan request may apply to the loan. In one example, the repayment method includes installment payment or fixed-amount payment for the total amount calculated by adding the loan fee to the predetermined amount of money. When the loan amount (predetermined amount) is determined, the loan processing module 1127 associates it with the account information on the first user (see, for example, FIG. 3).

The above process allows the user to change the settlement method depending on the situation, even once the settlement method has been selected by the user, thereby enhancing the degree of freedom for settlement. For example, the process described above lends the predetermined amount of money to the first user even once the settlement (clearing) has been completed, thus allowing the user to experience a pseudo-installment or fixed-amount payment.

The first user easily receives the loan by selecting at least one settlement from the settlement history. In this way, the above process facilitates the user's operation of receiving the loan. For the user, there may a case where money becomes necessary after the settlement by electronic payment is completed. In this case, the user may select the predetermined settlement from the settlement history, and may receive the amount of money less than or equal to the settlement amount included in the predetermined settlement.

The server 110 may provide predetermined services, including e-commerce services or settlement services. In one example, executing the program 1121 stored in the memory 112 may provide e-commerce or settlement services.

The above process allows the business operator to provide e-commerce services or electronic payment services while developing a money lending business to a first user.

As described above, the settlement history information may be acquired from a storage device (e.g., memory 112) that stores information on predetermined services, including e-commerce services or electronic payment services, or from another (a third) information processing device (e.g., server 150) that performs a service in conjunction with the server 110.

The above process allows the business operator to easily use the settlement history information related to e-commerce services or electronic payment services managed by their own device. This also allows the business operator to acquire and use the settlement history information from another information processing device that provides services in conjunction with the business provider.

When the settlement information contains product information, the settlement control module 1126 may include the product information in the settlement history information. The settlement control module 1126 may set the settlement information containing product information as the selectable settlement information.

When the settlement information does not contain product information, the settlement control module 1126 may prompt the user to read the receipt and/or register the product information. For example, when the settlement control module 1126 identifies the settlement for 100,000 yen at AAA Electric based on the settlement information, it may suggest by displaying a pop-up screen to the user's terminal 120, so as to prompt the user to perform the OCR (Optical Character Reader) processing via receipt photography or input manually to add the product information.

The settlement control module 1126 may also prompt the user to register product information if the product purchased through electronic payment meets predetermined conditions for product registration. The following examples are given as the predetermined conditions for product registration:
when the product is in a category that is likely to be listed based on the past listing history of the user's e-commerce service;
when the product is in a category of products that are purchased a lot from the past purchase status of the user's e-commerce service;
when the product is in a category where the transactions are permitted in the electronic commerce service; and
when the product matches the specified category, price, and store of purchase.

The settlement control module 1126 may also allow a first user to select settlement information that meets a predetermined condition for loaning. As an example of the predetermined condition, the settlement control module 1126 may allow the first user to select settlement information below the maximum amount that can be loaned to the first user. For example, a maximum loan amount may be set for the first user based on the credit information of the user. In that case, the settlement control module 1126 may not include the settlement information containing the settlement amount greater than the maximum loan amount in the settlement history information or may not allow the user to select such information.

The above process prevents the system from lending more money than the amount the first user can repay, thereby providing a sound financial environment for them.

As an example of the predetermined condition, the settlement control module 1126 may allow the first user to select settlement information within a predetermined period of time from the settlement date, settlement information in a predetermined number or less, or settlement information with the settlement amount of money less than or equal to a predetermined amount of money. For example, the settlement control module 1126 may not include the settlements that are more than three months ago, more than five settlements, or more than 50,000 yen in the settlement history information, or may not allow the user to select such settlement information. A plurality of these predetermined conditions may be combined. For example, the settlement information of less than 50,000 yen paid within 3 months may be included in the settlement history information, or it may be set as selectable.

The above processing prevents the system from lending the amount of money more than necessary to the first user by limiting the settlements that can be lent to such a user, thereby providing a sound financial environment for them.

As an example of the predetermined condition, the settlement control module 1126 may allow the first user to select settlement information for products purchased using a linked e-commerce service. For example, the settlement control module 1126 may not include the settlement information other than that for a product purchased using a linked e-commerce service in the settlement history information, or may not allow the user to select such settlement information.

The above process enables a loan to the first user for the settlement of a product purchased using the e-commerce service, allowing the first user to repay the loaned amount of money with the money that would be obtained by listing the product for sales.

As an example of the predetermined condition, the settlement control module 1126 may allow the first user to select settlement information for products that can be listed on the e-commerce platform. For example, the settlement control module 1126 may determine whether a product can be listed on the e-commerce service based on the product information included in the settlement information, and may not include the settlement for the product that cannot be listed in the settlement history information, or may not allow the user to select such settlement information. The determination on whether or not a product can be listed on the e-commerce service may be based on the category or the price of the product.

The above process enables a loan to the first user for the settlement of a product that can be listed in the e-commerce service, allowing the first user to list the product for sales to repay the loaned amount of money.

As an example of the predetermined condition, the settlement control module 1126 may disallow selection more than once for single settlement information. For example, the settlement control module 1126 may flag the settlement information for which a loan request has been made, so that the next time onward, the settlement information that has been loaned once will not be included in the settlement history information, or may not allow the first user to select such settlement information.

The above process prevents the system from repeatedly lending money to the first user for the same settlement, thereby providing a sound financial environment for them.

As an example of the predetermined condition, the settlement control module 1126 may acquire settlement history information including the settlement information before the completion of clearing. This example can set not only the settlement after the completion of the clearing but also the settlement before the completion of the clearing as the target to the settlement change. For example, the settlement control module 1126 allows selection of the settlement information before the completion of the settlement, and permits the change in the settlement method for it. Specifically, the settlement control module 1126 may change a lump-sum payment before the completion of clearing to deferred payment. In this case, the loan processing module 1127 does not need to loan before the completion of clearing, and may change the settlement method into installment payment.

The above process allows the user to change the settlement method depending on the situation, even once the settlement method has been selected by the user, thereby enhancing the degree of freedom for settlement.

The settlement control module 1126 may transmit settlement history information including the settlement information whose settlement method can be changed to the terminal 120 at a predetermined timing, and propose displaying of the settlement history to the user. For example, the settlement history information includes the settlement information that satisfies a predetermined condition on the proposal. The following examples are given as the predetermined conditions for the proposal:
a combination of multiple pieces of settlement information whose total settlement amount is closest to the maximum amount of money, with the maximum loan amount as the maximum;
payment information for products in the category that the user has listed or purchased more than a specified number of times on the e-commerce platform; and
a predetermined number of pieces of settlement information in the descending order of settlement amount.

The settlement control module 1126 may have sorting and filtering functions. The settlement information on a product that is likely to be sold by listing the product may be proposed, whereby the withdrawal date and the money-receiving date may be brought closer in the future.

The loan processing module 1127 may lend a predetermined amount of money specified by a predetermined method to the first user. In one example, the loan processing module 1127 may set the loan amount to an amount based on the settlement amount included in the selected settlement information or the settlement amount. In another example, the loan processing module 1127 may set the loan amount to an amount that the user selects while setting the maximum loanable amount or settlement amount as the upper limit. For example, if the settlement amount is 10,010 yen, the user may be allowed to select a loan amount such as 10,000 yen, 5,000 yen, or 20,000 yen, or the user may determine the loan amount at their discretion. The loan processing module 1127 may be controlled not to make a new loan if the repayment of a loan is not completed.

The loan processing module 1127 may also set the repayment date and method for repayment on the loan amount. For example, as a method of determining the repayment date, there are the following cases: the repayment date is calculated from the date when the loan is made to a first user; and the repayment date is calculated from the settlement date included in the selected settlement information. The loan processing module 1127 may allow the user to select the repayment date, and may set any one of the repayment dates by default. Repayment methods include lump-sum payment, installment payment, and fixed-amount payment, and the loan processing module 1127 may allow the user to select the repayment method or set any one of them by default.

In the case of fixed-amount repayment, the maximum or minimum monthly amount of money may be determined based on the amount loaned. Further, in the case of fixed-amount repayment, the loan processing module 1127 may automatically set the repayment amount or allow the first user to select the repayment amount of money within a predetermined range.

If a predetermined condition on the timing is met, the settlement control module 1126 may instruct the terminal 120 to perform the function of displaying the settlement history information including loanable settlement information. The following examples are given as the predetermined conditions for the timing:
when the balance of the user's account is less than a predetermined amount; and
when settlement of more than a predetermined amount happens within a predetermined period.

The predetermined amount may be determined by the user or may be determined based on the user's action history. The user's action history may include actions related to settlement such as the user's settlement history and loan status. For example, although the average settlement amount in the past months is 5,000 yen, the total settlement amount in a certain month exceeds 50,000 yen. This case may be determined that the predetermined condition for the timing is met.

When determining the repayment amount and period for the loan, the loan processing module 1127 may send simulation information on the repayment plan to the terminal 120 of the first user.

The one or more processors 111 described above read each module from the memory 112 for execution as needed. For example, the one or more processors 111 may execute the settlement control module 1126, the loan processing module 1127, and the transaction control module 1128 to configure a settlement control unit, a loan processing unit, and a transaction control unit, respectively.

(2) Configuration of Terminal 120

The terminal 120 has a processor 121, a memory 122, a storage 123, an input/output I/F 124, an input device 125, an output device 126, a transmission/reception unit 127, and a reading unit 128.

The processing, functions, or methods implemented through the execution of the processor 121 may be realized by machine learning, AI (Artificial Intelligence), or the like within a feasible range.

The input device 125 receives various operations by the user with the terminal 120.

The transmission/reception unit 127 transmits and receives data to and from the server 110 and other devices in accordance with an instruction from the processor 121. In one example, when the user logs into the server 110, the transmission/reception 127 connects a session for communication with the server 110 using HTTPS or the like. Then, the transmission/reception unit 127 stores the communication address and the like of the server 110 in association with the ID of the connected session for communication. Then, the transmission/reception unit 127 transmits data to the server 110 using the connected session for communication.

The processor 121 performs the process for use of predetermined services provided by server 110.

In one embodiment, the memory 122 stores a program 1221 described below, a settlement processing module 1222, a transaction processing module 1223, a display control module 1224 and a data structures, or a subset thereof. The information stored in the memory 122 may be stored in another storage device (e.g., a storage 123).

As described above, the program 1221 is a program loaded from the storage 123, and contains instructions, for example, related to each embodiment.

The settlement processing module 1222 executes processing related to electronic payments. In one example, the settlement processing module 1222 executes a settlement of store-scan type, in which the user's information is coded and the code is read by a store terminal, or a settlement of user-scan type, in which a code containing the store's information is read.

The transaction processing module 1223 executes purchase/sales transaction processing of a product on the e-commerce platform. In one example, the transaction processing module 1223 executes the processing of listing a product and purchasing a product on the e-commerce platform. The transaction processing module 1223 is an optional module.

The display control module 1224 controls the output device 126 to display screen data related to the electronic payment service or the electronic commerce platform. In one example, the display control module 1224 controls to display the screen for listing a product or to display the screen for purchasing a product. The display control module 1224 also may control to display a two-dimensional code including user information on the screen at the time of settlement at the store.

The display control module 1224 also controls to output the settlement history information including one or more pieces of settlement information on the first user to the screen of the output device 126. In one example, when receiving a display proposal for settlement history information from the server 110, the display control module 1224 proposes the display of the settlement history information to the user with a pop-up screen. When receiving a display operation of the settlement history information by the user, the display control module 1224 outputs the settlement history information to the screen of the output device 126.

The display control module 1222 also selects at least one piece of settlement information from the settlement history information displayed on the screen, in response to the operation by the first user. For example, the settlement processing module 1222 receives a user operation to the input device 125 and selects the settlement information subjected to the operation from the settlement history information.

The settlement processing module 1222 sets the amount of money based on the settlement amount included in the at least one piece of settlement information selected by the user as the amount to be loaned, and instructs the display control module 1224 to display it on the screen of the output device 126. The settlement processing module 1222 also requests another information processing device (e.g., server 110) to provide a loan in the amount of money determined in response to the first user's operation. For example, the settlement processing module 1222 sends the user's identification information, identification information indicating the selected at least one piece of settlement information, the determined amount of money, and the loan request to the server 110 via the transmission/reception unit 127.

The settlement processing module 1222 acquires the processing result related to the loan from the other information processing device, to which the loan request has sent, via the transmission/reception unit 127. The display control module 1224 controls to display the acquired processing result on the screen of the output device 126.

The above processing allows the user to easily receive the loan by selecting settlement information from the settlement history information. The user also can experience a pseudo deferred payment such as fixed-amount payment and installment payment.

The one or more processors 121 described above read each module from the memory 122 for execution as needed. For example, the one or more processors 121 may execute the settlement control module 1222, the transaction processing module 1223, and the display control module 1224 to configure a settlement processing unit, a transaction processing unit, and a display control unit, respectively.

Operating Process in Embodiment

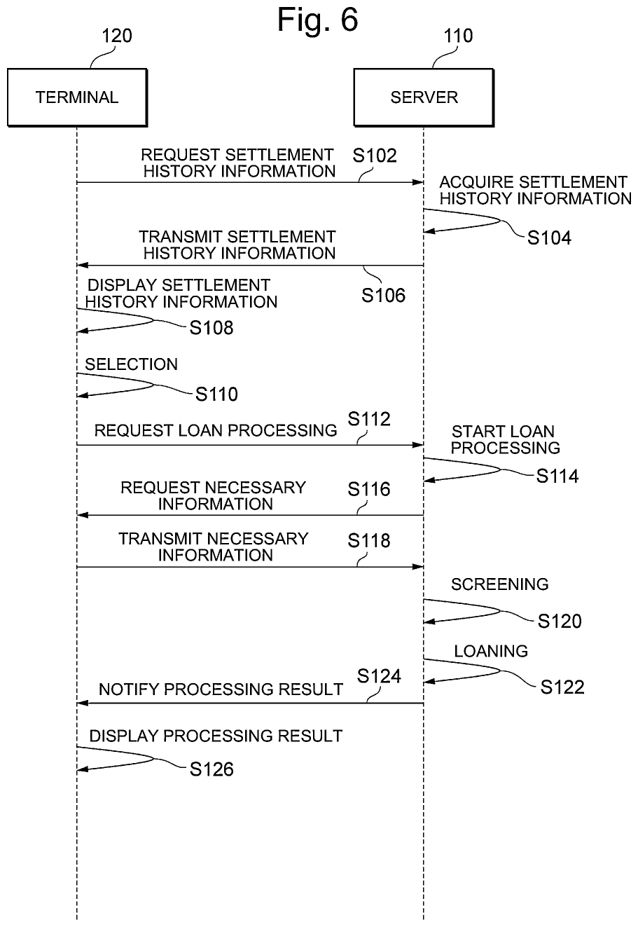

Referring to FIG. 6, the processing of the information processing system 1 for the embodiment is described below. FIG. 6 shows an example of the sequence of processing of the information processing system 1 in the embodiment. FIG. 6 shows an example of the process where the user performs display operation of the settlement history to the terminal 120.

Step S102: The settlement processing module 1222 of the user's terminal 120 receives the operation of displaying the settlement history from the user and requests the server 110 to acquire the settlement history information.

Step S104: When receiving a request for the settlement history information, the settlement control module 1126 of the server 110 extracts the settlement information on the first user who made the request and acquires the settlement history information including the extracted settlement information.

Step S106: The settlement control module 1126 of the server 110 transmits the settlement history information to the terminal 120 that made a request for it via the transmission/reception unit 117.

Step S108: The display control module 1224 of the user's terminal 120 displays the acquired settlement history information on the screen of the output device 126.

Step S110: The settlement processing module 1222 of the user's terminal 120 accepts user operation of selecting at least one piece of settlement information from the settlement history information via the input device 125.

Step S112: The settlement processing module 1222 of the user's terminal 120 sends the user's identification information, the identification information of the selected settlement information, and the loan processing request to the server 110 via the transmission/reception unit 127. At this time, when the user determines a predetermined amount of money as the loan amount, the determined predetermined amount of money is also transmitted.

Step S114: When receiving a request for loan processing, the loan processing module 1127 of the server 110 starts the loan processing.

Step S116: For example, the loan processing module 1127 of the server 110 requests the information necessary for the loan from the terminal 120. At this step, the necessary information can be obtained from the user information if available, and in addition to the information required for each loan (e.g., purpose of use, annual income, amount borrowed from other companies), information that cannot obtained from the user information is also requested.

Step S118: The settlement processing module 1222 of the terminal 120 obtains the necessary information selected or set by the user and transmits it to the server 110 via the transmission/reception unit 127.

Step S120: The loan processing module 1127 of the server 110 executes a screening process to determine whether or not a loan may be granted to the user who has requested the loan. In one example, for the screening process, the loan processing module 1127 sends the information of the user, who a prospective loan user, to a third-party institution such as CIC, to obtain the credit information on the user. The loan processing module 1127 uses the credit information obtained from the third-party institution to determine whether a loan may be granted to the user. For example, if the credit information includes information on a predetermined item, such as delayed credit clearance, the loan processing module 1127 determines that the loan cannot be granted. The loan processing module 1127 of the server 110 may obtain the result of the screening process that is examined using the credit information obtained from a third-party institution.

Step S122: When it is determined that the user may be provided with loan, the loan processing module 1127 of the server 110 executes the process of lending the predetermined amount of money to the first user. For example, the loan processing module 1127 sets the repayment date and repayment method, adds a predetermined amount of money to the user's account, and executes the loan processing of the predetermined amount of money.

Step S124: The loan processing module 1127 of the server 110 notifies the user's terminal 120 of the processing result, including whether the loan is approved or not, via the transmission/reception unit 117.

Step S126: The display control module 1224 of the user's terminal 120 controls to display the acquired processing result on the screen.

Example of Screen

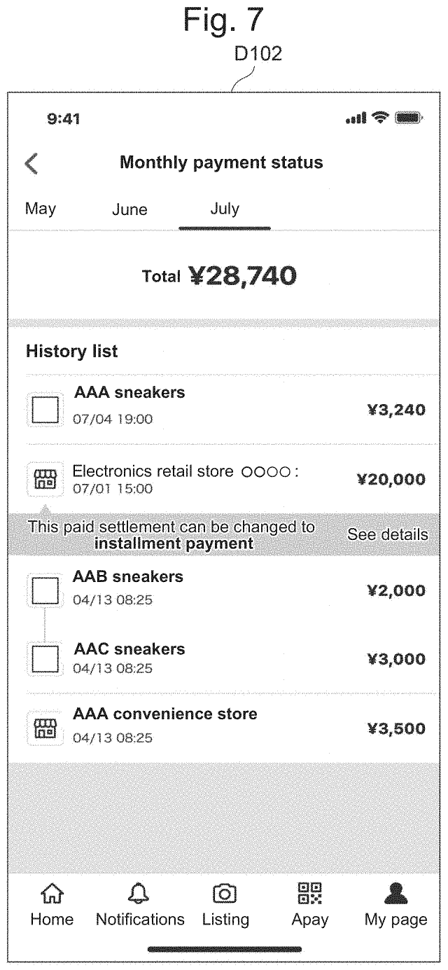

Referring next to FIG. 7, the following describes an example screen displayed on the user's terminal 120. FIG. 7 shows an example of settlement history displayed on the screen of the terminal 120 according to one embodiment. In the example shown in FIG. 7, the settlement history including the settlement list for a certain user is displayed on the screen D102 based on the settlement history information.

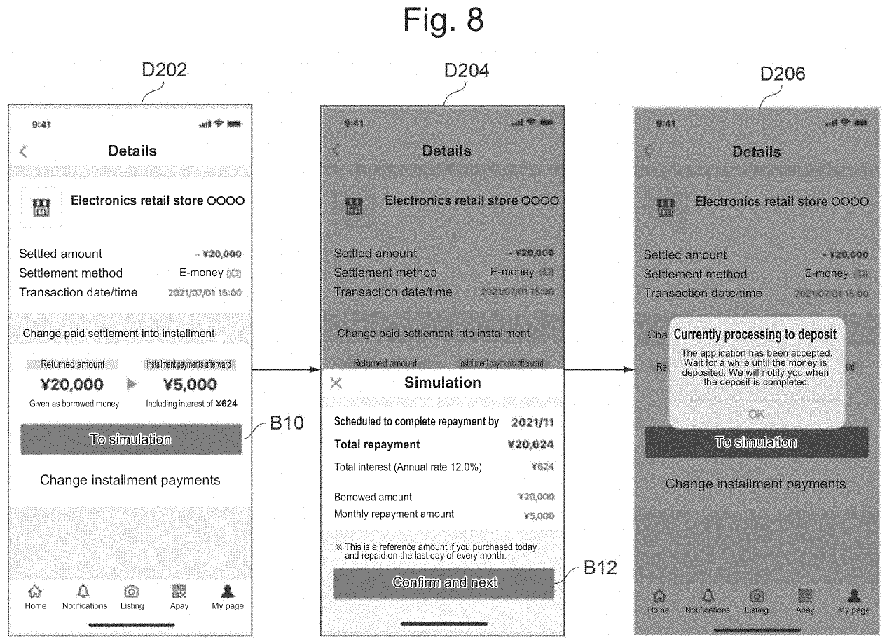

For example, the settlement history list on the screen D102 includes “electronics retail store ∘∘∘∘”, where the repayment method can be changed in the settlement. At the bottom of this settlement field, the message “This paid settlement can be changed to installment payment” is displayed, and the user can select this settlement. When this settlement is selected by the user, the screen related to the loan processing shown in FIG. 8 will be displayed.

FIG. 8 shows an example of screen transitions related to the loan displayed on the screen of the terminal 120 according to one embodiment. The screen D202 shown in FIG. 8 displays the settlement information selected by the user at the upper part, and displays the repayment amount of the loan when changing to the installment payment at the central part.

The screen D202 also displays a UI button B10 that allows the user to confirm the simulation when the installment payment is made by the set installment method, and a UI button for changing the amount of money for installment payment. When the user presses the UI button B10, the screen D202 transitions to the screen D204.

On the screen D204, an area showing the simulation result is superimposed on the screen D202. The area displayed on the screen D202 may be grayed out in order to improve visibility.

The area of the simulation result on screen D204 displays the month when the repayment is scheduled to be completed, the total repayment amount, the total interest, the borrowed amount (loan amount), the monthly repayment amount, and a UI button B12 of “Confirm and Next” to proceed with the borrowing (loan). When the user presses the UI button B12, the screen D204 transitions to the screen D206.

The screen D206 displays that the money-sending process is in progress. For example, such screen transitions as described above allow the user to easily change the repayment method for the settlement for which payment (clearing) has been completed. For a settlement that has already been paid, a predetermined amount of money is lent to the user, and the repayment method is considered as the changed settlement method. This allows the user to experience a pseudo installment or fixed-amount payment.

The disclosed technology is not limited to the above embodiments, and can be embodied variously without departing from the gist of the disclosed technology. For example, the above-mentioned processing steps can be reordered or executed in parallel within a range that does not cause a contradiction in the processing contents.

For example, the above embodiments describe an example of electronic money, such as prepaid and postpaid, which is applicable to credit cards, which represent cash as a digitized numerical value. In the case of credit cards, the settlement is made later in a lump sum on a predetermined date. For the transactions that have already been settled, users are allowed to experience fixed-amount or installment payments by selecting at least one piece of settlement information from the settlement statement and performing the loan process described above. The embodiments above describe the loan amount that is an amount less than or equal to the settlement amount, which may be greater than or equal to the settlement amount and less than or equal to a predetermined amount. The predetermined amount in this case may be the maximum loan amount of the user.

What is claimed is:

1. A method for processing information performed by one or more processors of a first information processing device, the method comprising:
acquiring settlement history information from a unit storing settlement history information including at least one piece of settlement information on each of a plurality of users, the acquired settlement history information containing at least one piece of settlement information on a first user;
specifying at least one piece of settlement information from the settlement history information, in response to operation by the first user with a second information processing device, on which the settlement history information is displayed;
displaying an amount of money based on a settlement amount included in the at least one piece of settlement information on the second information processing device, the displayed amount being an amount to be loaned to the first user; and
lending the amount of money determined in response to the operation by the first user with the second information processing device to the first user.

2. The method according to claim 1, further comprising providing a predetermined service including an e-commerce service or a settlement service.

3. The method according to claim 2, wherein the settlement history information includes settlement history information acquired from a storage device storing information on the predetermined service or settlement history information acquired from a third information processing device that performs a service in conjunction with the first information processing device.

4. The method according to claim 1, wherein the specifying further includes enabling selection of settlement information less than or equal to a maximum amount of money that can be loaned to the first user.

5. The method according to claim 1, wherein the specifying includes enabling selection of settlement information within a predetermined period from a settlement date, settlement information in a predetermined number or less, or settlement information with a settlement amount of money less than or equal to a predetermined amount of money.

6. The method according to claim 2, wherein the specifying includes enabling selection of settlement information on a product purchased using the e-commerce service.

7. The method according to claim 2, wherein the specifying includes enabling selection of settlement information on a product that can be listed on the e-commerce service.

8. The method according to claim 1, wherein the specifying includes disabling selection of one settlement information more than once.

9. The method according to claim 1, wherein the specifying includes acquiring settlement history information including settlement information before completion of clearing.

10. A non-transitory computer-readable storage medium storing a program, which causes one or more processors of an information processing device to perform a method including:
acquiring settlement history information from a unit storing settlement history information including at least one piece of settlement information on each of a plurality of users, the acquired settlement history information containing at least one piece of settlement information on a first user;
specifying at least one piece of payment information from the payment history information, in response to operation by the first user with another information processing device, on which the payment history information is displayed;
displaying an amount of money based on a settlement amount included in the at least one piece of settlement information on the other information processing device, the displayed amount being an amount to be loaned to the first user; and
lending the amount of money determined in response to the operation by the first user with the other information processing device to the first user.

11. An information processing device including a memory storing a program and one or more processors, the one or more processors executing the program to perform a method including:
acquiring settlement history information from a unit storing settlement history information including at least one piece of settlement information on each of a plurality of users, the acquired settlement history information containing at least one piece of settlement information on a first user;
specifying the at least one piece of settlement information from the settlement history information, in response to operation by the first user with another information processing device, on which the settlement history information is displayed;
displaying an amount of money based on a settlement amount included in the at least one piece of settlement information on the other information processing device, the displayed amount being an amount to be loaned to the first user; and
lending the amount of money determined in response to the operation by the first user with the other information processing device to the first user.
